(19) United States
(12) Patent Application Publication
(10) Pub. No.: US 2010/0105822 A1
(43) Pub. Date: Apr. 29, 2010

(54) BIODEGRADABLE THERMOPLASTIC COMPOSITIONS

(75) Inventors: João Carlos Girioli, Campinas (BR); Derval dos Santos Rosa, Campinas (BR); Paulo Aparecido dos Santos, Vinhedo (BR)

Correspondence Address: SABIC - LNP-CE 08CE;SABIC Innovative Plastics - IP LEGAL, ONE PLASTICS AVENUE, PITTSFIELD, MA, 01201-3697, US

(73) Assignee: SABIC Innovative Plastics IP B.V., Pittsfield, MA (US)

(21) Appl. No.: 12/428,684

(22) Filed: Apr. 23, 2009

Related U.S. Application Data
(60) Provisional application No. 61/049,809, filed on May 2, 2008.
(60) Provisional application No. 61/051,074, filed on May 7, 2008.

(51) Int. Cl. C08K 5/09; C08L 67/04; C08L 55/02; C08L 77/00; C08K 3/22; C08K 3/10

(52) U.S. Cl. 524/398; 524/539; 524/502; 524/538; 524/431; 524/403

(57) ABSTRACT

A biodegradable thermoplastic composition that includes a polyhydroxyalkanoate polyester, a conventional polymer having a melting temperature of 220° C. or less, a compatibilizer and a pro-degradation additive. These compositions comply with global standards regarding biodegradable materials and may be used in a wide array of applications, such as cosmetic containers, cell phones, laptops, and packaging applications.

### CROSS REFERENCE TO RELATED APPLICATIONS

The present application claims priority to U.S. Provisional Patent Application No. 61/049,809 filed May 2, 2008 and to U.S. Provisional Patent Application No. 61/051,074 filed May 7, 2008, both of which are hereby incorporated by reference in their entirety.

### FIELD OF THE INVENTION

The present invention relates to thermoplastic compositions, and in particular to biodegradable thermoplastic compositions. The present invention also relates to methods of manufacturing these compositions and articles that include these compositions.

### BACKGROUND OF THE INVENTION

Plastic products do not degrade for many years. Plastic products in today's society contribute to many problems such as litter, waste of valuable landfill space and entombment of waste. The detrimental effects of synthetic polymers on the environment have become increasingly evident in recent decades, mainly because of the resistance of these materials to peroxidation and to degradation by water and microorganisms. The fact that biodegradable polymers can offer a substantially reduced impact on the environment, and effectively create a closed-loop life cycle, can mitigate the aforementioned shortcomings of petroleum based plastic articles.

Biodegradable polymers provide a strategy to overcome the stresses on fossil fuel resources, carbon footprint and the global environment. The biodegradation of polymers involves well-documented mechanisms, which can vary depending on the chemistry of the polymer. The reduced life cycle of biodegradable polymers make them ideal candidates for single use disposable products.

Within the industry, there are a wide variety of known biodegradable polymers, of which the aliphatic polyester group has had increasing global interest. Among the aliphatic polyesters, polyhydroxyalkanoates (PHA) present good mechanical properties, and compatibility with many types of polymers. Discovered in 1925, PHAs have been documented in more than 100 different forms in recent year. Within that array, polyhydroxybutyrate (PHB) and derivatives thereof have been at the forefront of academia. PHB is a natural, linear, homochiral, thermoplastic polyester produced by microorganism metabolism as intracellular fat deposits in response to limited nutrient availability. Once extracted, the PHB solidifies and demonstrates mechanical properties analogous to those of polypropylene. Other notable properties include: (1) better oxygen barrier than polypropylene (PP) and polyethylene terephthalate (PET), (2) water barrier performance lower than PP and (3) good resistance to solubility in water.

The degradation of PHB depends on the microbial activity of the environment and on the surface area of the sample. In addition, the crystallinity, molecular weight of the sample, and temperature are important factors that influence the growth of microorganisms on the polymer surface.

However, PHB also includes two important property deficiencies, thermal instability and brittleness, that have been identified and that need to be overcome before PHB can be utilized as a commercial product.

Accordingly, it would be beneficial to provide a biodegradable thermoplastic material that offers improved thermal stability and/or flexibility as compared to prior art biodegradable materials. It would also be beneficial to provide a biodegradable article that includes a biodegradable thermoplastic material that offers improved thermal stability and/or flexibility. It would be further beneficial to provide a method of making a biodegradable thermoplastic material that offers improved thermal stability and/or flexibility.

### BRIEF SUMMARY OF THE INVENTION

The present invention provides a biodegradable thermoplastic composition having improved thermal stability and/or flexibility. The compositions of the present invention include a polyhydroxyalkanoate polyester, a conventional polymer having a melting temperature of 220° C., a compatibilizer and a pro-degradation additive wherein the composition is biodegradable as based on global standards while also being capable of being used in commercial products. These compositions may be used in a variety of products such as, for example, cosmetic containers, cell phones, laptops, and packaging applications.

Accordingly, in one aspect, the present invention provides a thermoplastic composition including 10 to 80% by weight of a polyhydroxyalkanoate polyester; 10 to 80% by weight of a conventional polymer having a melting temperature of 220° C. or less; 0.5 to 10% by weight of a compatibilizer; and from 0.2 to 10% by weight of a pro-degradation additive.

In another aspect, the present invention provides a method of forming a thermoplastic composition including the steps of blending 10 to 80% by weight of a polyhydroxyalkanoate polyester; 10 to 80% by weight of a conventional polymer having a melting temperature of 220° C. or less; 0.5 to 10% by weight of a compatibilizer; and from 0.2 to 10% by weight of a pro-degradation additive.

In yet another aspect, the present invention provides an article of manufacture that includes a composition including 10 to 80% by weight of a polyhydroxyalkanoate polyester; 10 to 80% by weight of a conventional polymer having a melting temperature of 220° C. or less; 0.5 to 10% by weight of a compatibilizer; and from 0.2 to 10% by weight of a pro-degradation additive.

### BRIEF DESCRIPTION OF THE DRAWINGS

FIG. 1 shows the changes in the melt flow index of PP/PHB compositions with and without metal stearate.

FIG. 2 shows tension loss in PP/EMA compositions with and without PHB and with and without metal stearate.

FIG. 3 shows the weight loss with time of a PP/PHB/EMA composition, 57/40/3, with and without metal stearate.

FIG. 4 shows the weight loss with time of a HDPE/PHB/EMA composition, 57/40/3, with metal stearate.

FIG. 5 shows the tension loss with time of a HDPE/PHB/EMA composition, 57/40/3, with metal stearate.

FIG. 6 shows the elongation loss with time of a PA6/PHB/EMA composition, 57/40/3, with metal stearate.

FIG. 7 shows the tension loss with time of a PA6/PHB/EMA composition, 57/40/3, with metal stearate.

FIG. 8 shows the tension loss with time of an ABS/PHB/EMA composition, 57/40/3, with metal stearate.

FIG. 9 shows the weight loss with time of PP/PHB/PP grafted maleic anhydride composition, 57/40/3, with metal stearate.

FIG. 10 shows the tension loss with time of PP/PHB/PP grafted maleic anhydride composition, 57/40/3, with metal stearate.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the term “comprising” may include the embodiments “consisting of” and “consisting essentially of.” All ranges disclosed herein are inclusive of the endpoints and are independently combinable. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

The interest and the development of polymeric biodegradable materials have been growing a lot in the last years on a global scale and have generated great technological evolution in biodegradations terms. However, the high production cost of the biodegradable materials, in comparison with the conventional plastics has constituted a barrier for a lot of companies. Focus has been placed on generating biodegradable materials of low cost, which would facilitate market penetration. A blend of biodegradable polymer with commodity resins therefore would provide an advantage from both a cost and environmental perspective.

Accordingly, the present invention provides a biodegradable thermoplastic composition containing a polyhydroxyalkanoate polyester, a conventional polymer having a melting temperature of 220° C. or less, a compatibilizer and a pro-degradation additive, wherein the resulting compositions comply with global standards regarding biodegradable materials. Contrary to most prior art biodegradable materials, the compositions of the present invention do not suffer from insufficient thermal stability and/or brittleness. As such, the compositions of the present invention may be made by means of a continuous process such as extrusion and are capable of being molded into articles using a conventional molding process, such as injection molding.

The present invention relates to a biodegradable thermoplastic composition that offers improved thermal stability and/or flexibility. The present invention uses a conventional polymer having a melting temperature of 220° C. or less. This conventional polymer is provided to help provide improved thermal stability and/or flexibility to the thermoplastic composition, thereby helping remediate some of the deficiencies of using the biodegradable polyhydroxyalkanoate polyester. The use of the compatibilizer and the pro-degradation additive help form a composition capable of being formed by extrusion and/or used in an injection molding process while also helping to promote degradation of the conventional polymer such that the biodegradable thermoplastic composition of the present invention comply with global standards regarding biodegradable materials.

Accordingly, in one aspect, the thermoplastic compositions of the present invention include a polyhydroxyalkanoate polyester. The polyhydroxyalkanoate polyester is selected as the base material for the composition. Polyhydroxyalkanoates (PHA) are linear polyesters produced in nature by bacterial fermentation of sugar or lipids. In the case of PHAs, the monomers are 3-hydroxyalkanoates. An alkanoate is simply a fatty acid which is a linear molecule containing just carbon and hydrogen (an alkane) with a carboxyl group at one end (making an alkanoate). Furthermore, these monomers have a hydroxyl group (OH) at the 3rd carbon (what used to be called the beta position), making these beta or 3-hydroxyalkanoates. The hydroxyl group of one monomer is attached to the carboxyl group of another by an ester bond; these plastics are thus polyesters. The polyester linkage creates a molecule which has 3-carbon segments separated by oxygen atoms. The remainder of the monomer becomes a sidechain off the main backbone of the polymer

The most common type of PHA is PHB (poly-beta-hydroxybutyrate). They can be either thermoplastic or elastomeric materials, with melting points ranging from 40 to 180° C. Most of the PHAs encountered in nature are poly(beta-hydroxybutyrate) (PHB), in which the monomer unit is hydroxybutyric acid and the side chain is a methyl group. PHB has properties similar to those of PP (a conventional polymer), however it is stiffer and more brittle. It biodegrades in microbially active environments in 5-6 weeks. The action of some enzymes produced by microbes solubilizes PHB that is then absorbed through the cell wall and metabolized. PHB is normally broken down to carbon dioxide and water when degraded in aerobic conditions. In absence of oxygen the degradation is faster, and methane is also produced.

Examples of polyhydroxyalkanoate polyesters that may be used in the present invention include, but are not limited to, polyhydroxybutyrate, poly(3-hydroxybutyrate, polyhydroxyvalerate, polyhydroxyhexanoate, poly(3-hydroxybutyrate-co-3-hydroxyvalerate) copolymer, poly-hydroxybutyrate-co-polyhydroxyhexanoate copolymer, or a combination including at least one of the foregoing polyhydroxyalkanoate polyester polymers.

The amount of the polyhydroxyalkanoate polyester used in the thermoplastic compositions of the present invention may be based on the selected properties of the thermoplastic compositions as well as molded articles made from these compositions. Other factors include the amount and/or type of the conventional polymer used, the compatibilizer used, the pro-degradation additive used, the type of article to be formed and/or the presence of any other additives or fillers. In one embodiment, the polyhydroxyalkanoate polyester is present in amounts of from 10 to 80 wt. %. In another embodiment, the polyhydroxyalkanoate polyester is present in amounts from 20 to 70 wt. %. In still another embodiment, the polyhydroxyalkanoate polyester is present in amounts from 30 to 60 wt. %.

The composition of the PHA has a direct effect on the physical properties of the plastic. PHB, with its short methyl sidechain, is a very crystalline and very brittle polymer. Industrially, it is difficult to use because PHB melts at approximately 174° C. but begins to thermally degrade in the vicinity of the melting temperature (Tm), thus, making melt-processing difficult. Once thermal cleavage of the polymer chains initiates mechanical properties are reduced. In addition, PHB has an elongation at break that is 5-8%, which is only 1/7.5 and 1/20 of polypropylene (PP) and polyethylene terephthalate, respectively. Presumably, brittleness is caused by low nucleation density that arises from PHB's high purity. Thus, cracks can form in the large diameter, high volume spherulites, and cause the plastic to break. Accordingly, the compositions of the present invention blend the polyhydroxyalkanoate polyester with another polymer that possesses the selected properties such that a given application can be executed.

Accordingly, in addition to the polyhydroxyalkanoate polyester, the compositions of the present invention also include a conventional polymer having a melting temperature of 220° C. or less. As used herein, a “conventional” polymer is a non-biodegradable polymer that is conventionally used in many different plastic articles today. The conventional polymer is provided to help improve the thermal stability and/or flexibility of the thermoplastic composition, thereby helping to alleviate the problems associated with prior art biodegradable materials using PHB or other polyhydroxyalkanoate polyesters. By using a conventional polymer having a melting temperature of 220° C. in conjunction with a polyhydroxyalkanoate polyester, the compositions of the present invention have improved thermal stability and/or flexibility while also being biodegradable based on global standard ASTM D 6003.

The conventional polymer is selected such that it has a melting temperature of 220° C. or less since the polyhydroxyalkanoate polyester starts to degrade as processing temperatures exceed 200° C. and especially 220° C. Higher melting temperature polymers could be used in alternative embodiments if processing temperatures are kept below the degradation temperatures of the polyhydroxyalkanoate polyester or if alternative polymers are used as a biodegradable component in the compositions. Examples of conventional polymers that may be used in the present invention include, but are not limited to, a polyolefin, a polyamide, a polyester, such as PBT or PET, a styrene-containing polymer or a combination including at least one of the foregoing polymers. In one embodiment, the conventional polymer is a polyolefin, such as polypropylene, polyethylene, high-density polyethylene and/or low-density polyethylene.

The amount of the conventional polymer added to the thermoplastic compositions of the present invention may be based on the selected properties of the thermoplastic compositions as well as molded articles made from these compositions. Other factors include the amount and/or type of the polyhydroxyalkanoate polyester used, the compatibilizer used, the pro-degradation additive used, the type of article to be formed and/or the presence of any other additives or fillers. In one embodiment, the conventional polymer is present in amounts of from 10 to 80 wt. %. In another embodiment, the conventional polymer is present in amounts from 20 to 70 wt. %. In still another embodiment, the conventional polymer is present in amounts from 30 to 60 wt. %.

In addition to the polyhydroxyalkanoate polyester and the conventional polymer, the thermoplastic compositions of the present invention include a compatibilizer. The addition of the compatibilizer helps enable the polyhydroxyalkanoate polyester and the conventional polymer to generate suitable blend miscibility and to form a composition that is capable of being formed into an article that is useful in being formed into commercial products.

Examples of compatibilizers that may be used in the present invention include, but are not limited to, ethylene methylacrylate, maleic anhydride or a combination comprising at least one of the foregoing compatibilizers. In one embodiment, the compatibilizer is ethylene methylacrylate.

The amount of compatibilizer used in the thermoplastic composition is dependent on one more factors including, but not limited to, the polyhydroxyalkanoate polyester used, the conventional polymer used, and the presence of any other additives or fillers. In one embodiment, the amount of compatibilizer added is from 0.5 to 10% by weight of the thermoplastic composition. In another embodiment, the amount of compatibilizer added is from 1 to 8% by weight of the thermoplastic composition. In still another embodiment, the amount of compatibilizer added is from 2 to 6% by weight of the thermoplastic composition.

Lastly, the compositions of the present invention include a pro-degradation additive. The pro-degradation additive helps enhance the degradation of the conventional polymer. As such, the resulting thermoplastic compositions comply with global standards regarding biodegradable materials. The pro-degradation additive helps facilitate initiation of oxy-degradation in which the conventional polymer chains are systematically reduced in size as a result of free radical cleavage. While the pro-degradation additive alone will not render the final composition biodegradable, the use of the pro-degradation additive helps to biodegrade the conventional polymer while the polyhydroxyalkanoate polyester biodegrades without the use of the additive such that the overall composition is considered biodegradable.

Examples of pro-degradation additives that may be used in the present invention include, but are not limited to, a transition metal stearate, a cobalt-containing material, cerium oxide, or a combination including at least one of the foregoing pro-degradation additives. In one embodiment, the pro-degradation additive is a metal stearate, such as manganese stearate.

The amount of pro-degradation additive used in the thermoplastic composition is dependent on one more factors including, but not limited to, the conventional polymer used, the type of article to be formed and/or the presence of any other additives or fillers. In one embodiment, the amount of pro-degradation additive added is from 0.2 to 10% by weight of the thermoplastic composition. In another embodiment, the amount of pro-degradation additive added is from 0.5 to 5% by weight of the thermoplastic composition. In still another embodiment, the amount of pro-degradation additive added is from 0.8 to 3% by weight of the thermoplastic composition.

In addition to the polyhydroxyalkanoate polyester, the conventional polymer, the compatibilizer and the pro-degradation additive, the thermoplastic compositions of the present invention may include various additives ordinarily incorporated in resin compositions of this type. Mixtures of additives may be used. Such additives may be mixed at a suitable time during the mixing of the components for forming the composition. The one or more additives are included in the thermoplastic compositions to impart one or more selected characteristics to the thermoplastic compositions and any molded article made therefrom. Examples of additives that may be included in the present invention include, but are not limited to, heat stabilizers, process stabilizers, antioxidants, light stabilizers, plasticizers, antistatic agents, mold releasing agents, UV absorbers, lubricants, pigments, dyes, colorants, flow promoters or a combination of one or more of the foregoing additives.

Suitable heat stabilizers include, for example, organo phosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations including at least one of the foregoing heat stabilizers. Heat stabilizers are generally used in amounts of from 0.01 to 0.5 parts by weight based on 100 parts by weight of the total composition, excluding any filler.

Suitable antioxidants include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations including at least one of the foregoing antioxidants. Antioxidants are generally used in amounts of from 0.01 to 0.5 parts by weight, based on 100 parts by weight of the total composition, excluding any filler.

Suitable light stabilizers include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone or the like or combinations including at least one of the foregoing light stabilizers. Light stabilizers are generally used in amounts of from 0.1 to 1.0 parts by weight, based on 100 parts by weight of the total composition, excluding any filler.

Suitable plasticizers include, for example, phthalic acid esters such as dioctyl-4,5-epoxy-hexahydrophthalate, tris-(octoxycarbonylethyl)isocyanurate, tristearin, epoxidized soybean oil or the like, or combinations including at least one of the foregoing plasticizers. Plasticizers are generally used in amounts of from 0.5 to 3.0 parts by weight, based on 100 parts by weight of the total composition, excluding any filler.

Suitable antistatic agents include, for example, glycerol monostearate, sodium stearyl sulfonate, sodium dodecylbenzenesulfonate or the like, or combinations of the foregoing antistatic agents. In one embodiment, carbon fibers, carbon nanofibers, carbon nanotubes, carbon black, or any combination of the foregoing may be used in a polymeric resin containing chemical antistatic agents to render the composition electrostatically dissipative.

Suitable mold releasing agents include for example, metal stearate, stearyl stearate, pentaerythritol tetrastearate, beeswax, montan wax, paraffin wax, or the like, or combinations including at least one of the foregoing mold release agents. Mold releasing agents are generally used in amounts of from 0.1 to 1.0 parts by weight, based on 100 parts by weight of the total composition, excluding any filler.

Suitable UV absorbers include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenylacryloyl)oxy]methyl]propane (UVINUL™ 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than 100 nanometers; or the like, or combinations including at least one of the foregoing UV absorbers. UV absorbers are generally used in amounts of from 0.01 to 3.0 parts by weight, based on 100 parts by weight based on 100 parts by weight of the total composition, excluding any filler.

Suitable lubricants include for example, fatty acid esters such as alkyl stearyl esters, e.g., methyl stearate or the like; mixtures of methyl stearate and hydrophilic and hydrophobic surfactants including polyethylene glycol polymers, polypropylene glycol polymers, and copolymers thereof e.g., methyl stearate and polyethylene-polypropylene glycol copolymers in a suitable solvent; or combinations including at least one of the foregoing lubricants. Lubricants are generally used in amounts of from 0.1 to 5 parts by weight, based on 100 parts by weight of the total composition, excluding any filler.

Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates; sulfates and chromates; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations including at least one of the foregoing pigments. Pigments are generally used in amounts of from 1 to 10 parts by weight, based on 100 parts by weight based on 100 parts by weight of the total composition, excluding any filler.

Suitable dyes include, for example, organic dyes such as coumarin 460 (blue), coumarin 6 (green), nile red or the like; lanthanide complexes; hydrocarbon and substituted hydrocarbon dyes; polycyclic aromatic hydrocarbons; scintillation dyes (preferably oxazoles and oxadiazoles); aryl- or heteroaryl-substituted poly (2-8 olefins); carbocyanine dyes; phthalocyanine dyes and pigments; oxazine dyes; carbostyryl dyes; porphyrin dyes; acridine dyes; anthraquinone dyes; arylmethane dyes; azo dyes; diazonium dyes; nitro dyes; quinone imine dyes; tetrazolium dyes; thiazole dyes; perylene dyes, perinone dyes; bis-benzoxazolylthiophene (BBOT); and xanthene dyes; fluorophores such as anti-stokes shift dyes which absorb in the near infrared wavelength and emit in the visible wavelength, or the like; luminescent dyes such as 5-amino-9-diethyliminobenzo(a)phenoxazonium perchlorate; 7-amino-4-methylcarbostyryl; 7-amino-4-methylcoumarin; 3-(2′-benzimidazolyl)-7-N,N-diethylaminocoumarin; 3-(2′-benzothiazolyl)-7-diethylaminocoumarin; 2-(4-biphenyl)-5-(4-t-butylphenyl)-1,3,4-oxadiazole; 2-(4-biphenyl)-6-phenylbenzoxazole-1,3; 2,5-Bis-(4-biphenyl)-1)-1,3,4-oxadiazole; 2,5-bis-(4-biphenyl)-oxazole; 4,4′-bis-(2-butyloctyloxy)-p-quaterphenyl; p-bis(o-methylstyryl)-benzene; 5,9-diaminobenzo(a)phenoxazonium perchlorate; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-diethylamino-4-methylcoumarin; 7-diethylamino-4-trifluoromethylcoumarin; 2,2′-dimethyl-p-quaterphenyl; 2,2-dimethyl-p-terphenyl; 7-ethylamino-6-methyl-4-trifluoromethylcoumarin; 7-ethylamino-4-trifluoromethylcoumarin; nile red; rhodamine 700; oxazine 750; rhodamine 800; IR 125; IR 144; IR 140; IR 132; IR 26; IRS; diphenylhexatriene; diphenylbutadiene; tetraphenylbutadiene; naphthalene; anthracene; 9,10-diphenylanthracene; pyrene; chrysene; rubrene; coronene; phenanthrene or the like, or combinations including at least one of the foregoing dyes. Dyes are generally used in amounts of from 0.1 to 5 parts by weight, based on 100 parts by weight of the total composition, excluding any filler.

Suitable colorants include, for example titanium dioxide, anthraquinones, perylenes, perinones, indanthrones, quinacridones, xanthenes, oxazines, oxazolines, thioxanthenes, indigoids, thioindigoids, naphthalimides, cyanines, xanthenes, methines, lactones, coumarins, bis-benzoxazolylthiophene (BBOT), naphthalenetetracarboxylic derivatives, monoazo and diazo pigments, triarylmethanes, aminoketones, bis(styryl)biphenyl derivatives, and the like, as well as combinations including at least one of the foregoing colorants. Colorants are generally used in amounts of from 0.1 to 5 parts by weight, based on 100 parts by weight of the total composition, excluding any filler.

Suitable blowing agents include for example, low boiling halohydrocarbons and those that generate carbon dioxide; blowing agents that are solid at room temperature and when heated to temperatures higher than their decomposition temperature, generate gases such as nitrogen, carbon dioxide, ammonia gas, such as azodicarbonamide, metal salts of azodicarbonamide, 4,4′ oxybis(benzenesulfonylhydrazide), sodium bicarbonate, ammonium carbonate, or the like, or combinations including at least one of the foregoing blowing agents. Blowing agents are generally used in amounts of from 1 to 20 parts by weight, based on 100 parts by weight of the total composition, excluding any filler.

Additionally, materials to improve flow and other properties may be added to the composition, such as low molecular weight hydrocarbon resins. Particularly useful classes of low molecular weight hydrocarbon resins are those derived from petroleum C₅ to C₉ feedstock that are derived from unsaturated C₅ to C₉ monomers obtained from petroleum cracking Non-limiting examples include olefins, e.g. pentenes, hexenes, heptenes and the like; diolefins, e.g. pentadienes, hexadienes and the like; cyclic olefins and diolefins, e.g. cyclopentene, cyclopentadiene, cyclohexene, cyclohexadiene, methyl cyclopentadiene and the like; cyclic diolefin dienes, e.g., dicyclopentadiene, methylcyclopentadiene dimer and the like; and aromatic hydrocarbons, e.g. vinyltoluenes, indenes, methylindenes and the like. The resins can additionally be partially or fully hydrogenated.

The thermoplastic compositions of the present invention may be formed using any known method of combining multiple components to form a thermoplastic resin. In one embodiment, the components are first blended in a high-speed mixer. Other low shear processes including but not limited to hand mixing may also accomplish this blending. The blend is then fed into the throat of a twin-screw extruder via a hopper. Alternatively, one or more of the components may be incorporated into the composition by feeding directly into the extruder at the throat and/or downstream through a sidestuffer. The extruder is generally operated at a temperature higher than that necessary to cause the composition to flow. The extrudate is immediately quenched in a water batch and pelletized. The pellets so prepared when cutting the extrudate may be one-fourth inch long or less as desired. Such pellets may be used for subsequent molding, shaping, or forming.

Shaped, formed, or molded articles including the thermoplastic compositions are also provided. The thermoplastic compositions can be molded into useful shaped articles by a variety of means such as injection molding, extrusion, rotational molding, blow molding and thermoforming to form articles.

Examples of articles that may be made using the compositions of the present invention include, but are not limited to, injection-molded bottles, plastic films, cosmetic containers, cell phones, laptops, and packaging applications.

The present invention is further illustrated by the following non-limiting examples.

### EXAMPLES

In these examples, a biodegradable polymer according to one embodiment of the present invention was prepared. In this embodiment, the polyhydroxyalkanoate polyester was PHB while the conventional polymer having a melting temperature of 220° C. or less were: polypropylene (PP), high-density polyethylene (HDPE), polyamide 6 (PA6), and styrene-butadiene-acrylonytrile (ABS).

### Example 1

In this example, polypropylene, poly (3 hydroxybutyrate), manganese stearate and polyethylene graft-glycidyl methacrylate (PE-g-GMA) were hand mixed before introduction into an extruder. PP was thoroughly mixed with manganese stearate (1.0 wt %, in mass) and polyethylene graft-glycidyl methacrylate (PE-g-GMA) (3 wt %, in mass) and extruded using a one-screw extruder (Miotto ELM 25 Extrusion) with 25 mm diameter (φ). The extrusion conditions were as follows: the temperatures of heating of the cylinder of zones extruder 1, 2, 3 and headstock were 200° C./215° C./220° C./220° C., respectively. The L/D=25, the process used screws 60/150/60 mesh with a 5 kg capacity, 50 rpm and 110 to 285 Bar. This intermediate material was named Modified PP (PPm)

The PHB was dried for 60 minutes at 80° C. in a conventional oven. Modified PP and PHB blends in the different proportions (PPm)/PHB 100/0, 80/20, 60/40, 40/60, 20/80 wt % were then prepared. The mixtures were processed using temperatures ranging from 180 to 220° C. using the extrusion equipment of double-screw thread (L/D=13, D=25 mm, co-rotating, interpenetrating, screw thread with segmented shape), using rotation between 50 to 300 rpm. The quantity of manganese stearate used was 1.0 wt % in relation to the mass of the polypropylene used.

The blends prepared were then characterized using ASTM standards. The blends were characterized by Melt Flow Index according to ASTM D 1238. The results are set forth in Table 1.

TABLE 1
Effect of blending on MFI.

| | PPm/PHB- | PPm/PHB- | PPm/PHB- | PPm/PHB- |
|---|---|---|---|---|
| PPm 100% | 80/20% | 60/40% | 40/60% | 20/80% |
| 4.02 ± 0.03 | 6.3 ± 0.3 | 11 ± 1 | 16 ± 2 | 18 ± 2 |

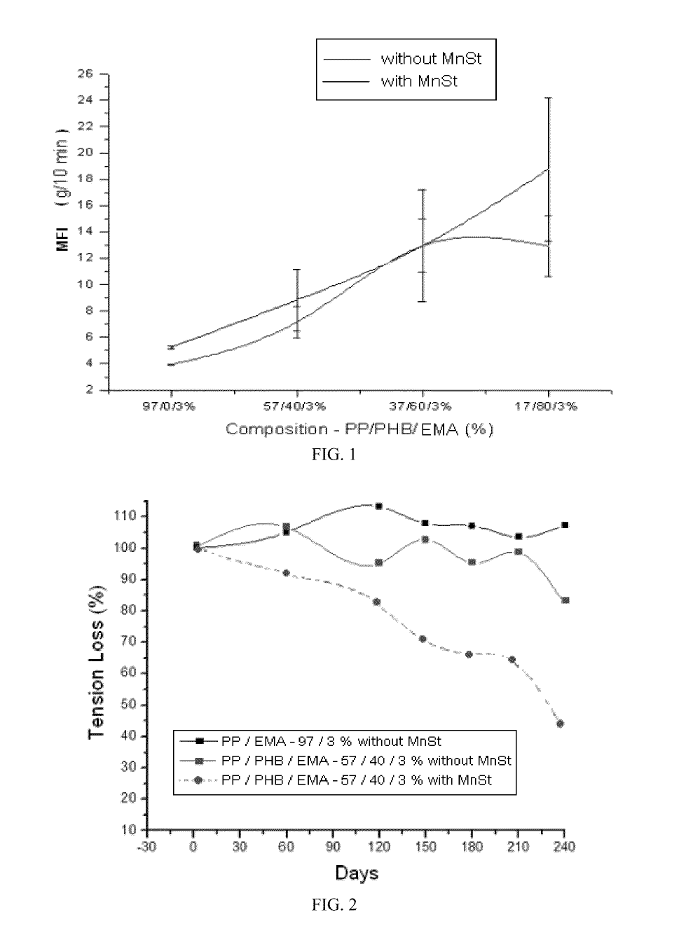

As may be seen in FIG. 1, the addition of manganese stearate does not affect the melt flow index of the compositions such that the resulting compositions have similar melt-mixing process for forming resin blends as well as being capable of being used in molding processes to form articles from the resulting compositions.

Next, the tensile properties of the compositions were evaluated. As may be seen in Table 2, the addition of the polypropylene helped produce less brittle materials while maintaining the tensile strength of the compositions.

TABLE 2
Overview of Tensile mechanical properties of PP blends

| | Elongation at | Tensile strength at |
|---|---|---|
| | break | break |
| PPm/PHB | (%) | (MPa) |
| 100/0 | 49.8 ± 0.7 | 18.2 ± 0.2 |
| 80/20 | 39 ± 1 | 20.4 ± 0.1 |
| 60/40 | 24 ± 0.8 | 21.2 ± 0.6 |
| 40/60 | 12.7 ± 0.7 | 23.5 ± 0.7 |
| 20/80 | 12.7 ± 0.5 | 31.1 ± 0.6 |
| 0/100 | 11.8 ± 0.3 | 20.1 ± 0.1 |

PHB had a smaller elongation at break and this property increased with increasing PP content in the blend. Relative to pure PP, there was no trend in tensile strength at break with the addition of PHB. The two polymers are partially compatible, due the presence of ethylene methyl acrylate copolymer serving as compatibilizer. The blends 80/20, 60/40, 40/60 had PP as continuous phase and PHB is discontinuous phase. The blend 20/80 had a greatest tensile strength because a co-continuous phase morphology was formed.

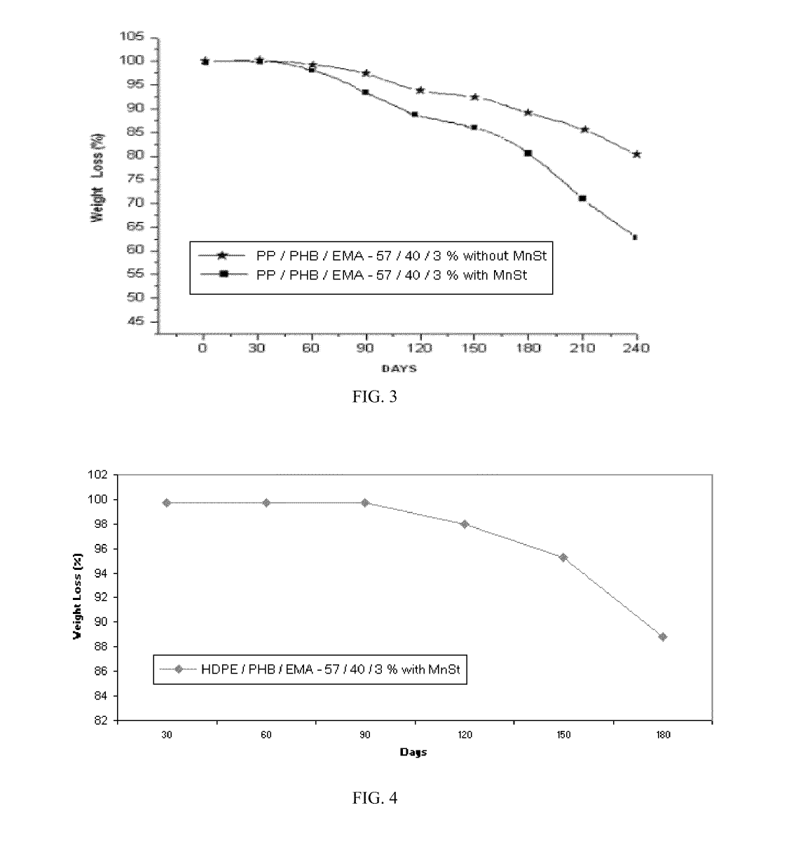

Next, the biodegradability of the samples was tested. Biodegradability was based on tensile strength retention and per visual inspection, as measured according to ASTM D 6003. The tensile strength of specimens was measured according to ASTM D 638 and then the specimens were buried in simulated soil compost at room temperature (24° C.). The simulated soil consisted of 23% loamy silt, 23% organic matter (cow manure), 23% sand and 31% distilled water (all wt/wt). Biodegradation was monitored for 210 days by measuring the tensile strength retention approximately each 30 days. The buried specimens were recovered, washed with distilled water and dried at room temperature until there was no further variation in weight, after which they were evaluated for tensile strength. Additionally, the weight loss of the specimens were tracked along the burring time. The experiments were done in triplicate. The results may be seen in FIGS. 2 and 3. As may be seen, the addition of the manganese stearate substantially decreased the tensile strength, increased the weight loss and caused visible effects of degradation of the samples and, therefore, enabled the sample to be considered biodegradable rating 3 as per Table X2.1 under ASTM D 6003.

### Example 2

In this example, conventional polymers: High density polyethylene (HDPE), a polyamide 6 (PA6), and styrene-butadiene-acrylonytrile (ABS) were blended with PHB (ratio: Conventional polymer/PHB=57/40). Each one of these polymers were hand mixed with poly (3 hydroxybutyrate), manganese stearate and polyethylene graft-glycidyl methacrylate (PE-g-GMA). The mixtures were thoroughly mixed with manganese stearate (1.0 wt %, in mass) and polyethylene graft-glycidyl methacrylate (PE-g-GMA) (3 wt %, in mass) and extruded using a twin-screw extruder (COPERION—W&P ZSK 25) with 25 mm diameter (φ). The extrusion conditions were as follows: the temperatures of heating of the cylinder of zones extruder 1, 2, 3, 4 and headstock were 200° C./210° C./215° C./220° C./220° C., respectively. The L/D is 38. The process used modular screws with pre-established configurations of the transport elements are employed: conventional screw elements, relaxation elements, sheering elements, and high sheering elements.

The blends prepared were then characterized using ASTM standards. The mechanical properties of the compositions were evaluated and are shown on Table 3.

TABLE 3
Overview of mechanical properties of blends.

| | HDPE/PHB | PA6/PHB | ABS/PHB |
|---|---|---|---|
| Tensile Strenght (Mpa) | 18.4 | 29.4 | 31.7 |
| Elongation (%) | 9.6 | 10.4 | 10.3 |
| Flexural Strenght (Mpa) | 26.00 | 49 | 51.8 |
| Flexural Modulus (Mpa) | 1152 | 2106 | 2720 |
| Izod Impact (J/m) | 33.8 | 60 | 26 |
| HDT (3.2 mm) - 0.45 MPa | 81 | 104 | 90 |
| HDT (6.4 mm) - 1.82 MPa | 55 | 60 | 84 |

Next, the blend samples were thermal aged for 240 hours at 90° C., in an air circulating oven, to simulate the life performance in use.

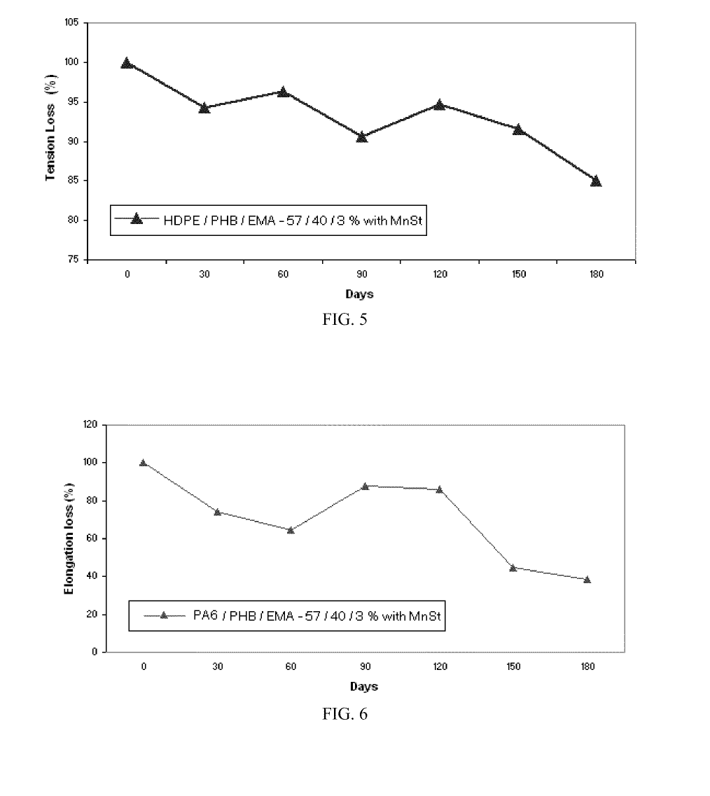

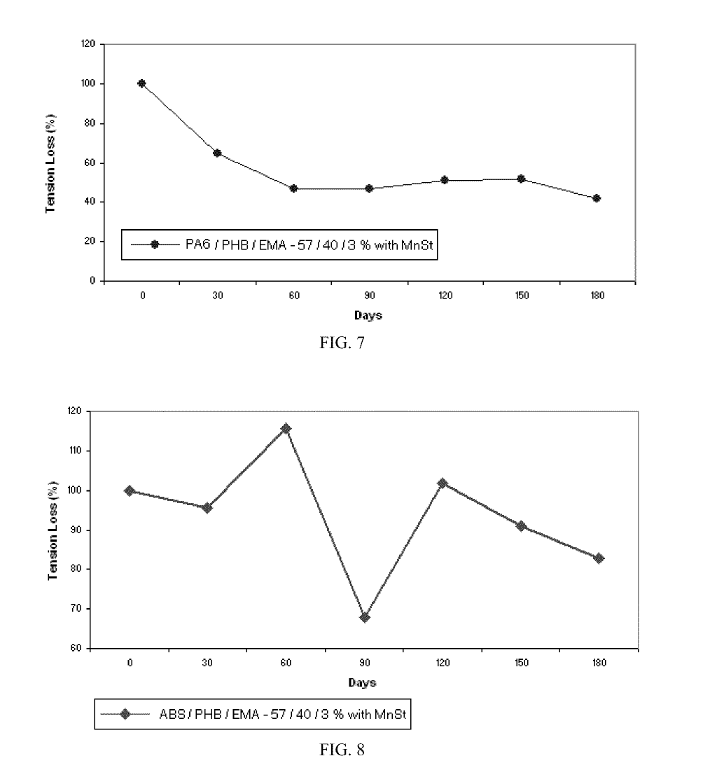

Next, the biodegradability of the samples was tested. Biodegradability was based on tensile strength retention and per visual inspection, as measured according to ASTM D 6003. The tensile strength of specimens was measured according to ASTM D 638 and then the specimens were buried in simulated soil compost at room temperature (24° C.). The simulated soil consisted of 23% loamy silt, 23% organic matter (cow manure), 23% sand and 31% distilled water (all wt/wt). Biodegradation was monitored for 180 days by measuring the tensile strength retention approximately each 30 days. The buried specimens were recovered, washed with distilled water and dried at room temperature until there was no further variation in weight, after which they were evaluated for tensile strength. Additionally, the weight loss of the specimens was tracked along the burring time. The experiments were done in triplicate. The results may be seen in FIGS. 4, 5, 6, 7 and 8. As may be seen, the simulated soil compost substantially decreased the tensile strength, elongation to break, and increased the weight loss and caused visible effects of degradation of the samples and, therefore, enabled the sample to be considered biodegradable rating 3 as per Table X2.1 under ASTM D 6003.

### Example 3

In this example, polypropylene, manganese stearate (1:0 wt %, in mass) and polypropylene graft-maleic anhydride (5 wt %, in mass) were blended with poly (3 hydroxybutyrate). All components were hand mixed (ratio: Conventional polymer/PHB=60/40). The mixtures were extruded using a twin-screw extruder (COPERION—W&P ZSK 25) with 25 mm diameter (φ). The extrusion conditions were as follows: the temperatures of heating of the cylinder of zones extruder 1, 2, 3, 4 and headstock were 200° C./220° C./230° C./230° C./230° C., respectively. The L/D=38, the process used modular screws with pre-established configurations of the transport elements are employed: conventional screw elements, relaxation elements, sheering elements, and high sheering elements.

The blends prepared were then characterized using ASTM standards. The mechanical properties of the compositions were evaluated and are shown on Table 4.

TABLE 4
Overview of mechanical properties of blends.

| | PP/PHB/PP-Maleic Anhydride |
|---|---|
| Tensile Strenght (Mpa) | 24.66 |
| Elongation (%) | 12.8 |
| Flexural Strenght (Mpa) | 38.2 |
| Flexural Modulus (Mpa) | 1779 |
| Izod Impact (J/m) | 32.3 |
| HDT (3.2 mm) - 0.45 MPa | 79.4 |
| HDT (6.4 mm) - 1.82 MPa | 64.2 |

Next, the blend samples were thermal aged for 240 h at 90° C., in an air circulating oven, to simulate the life performance in use.

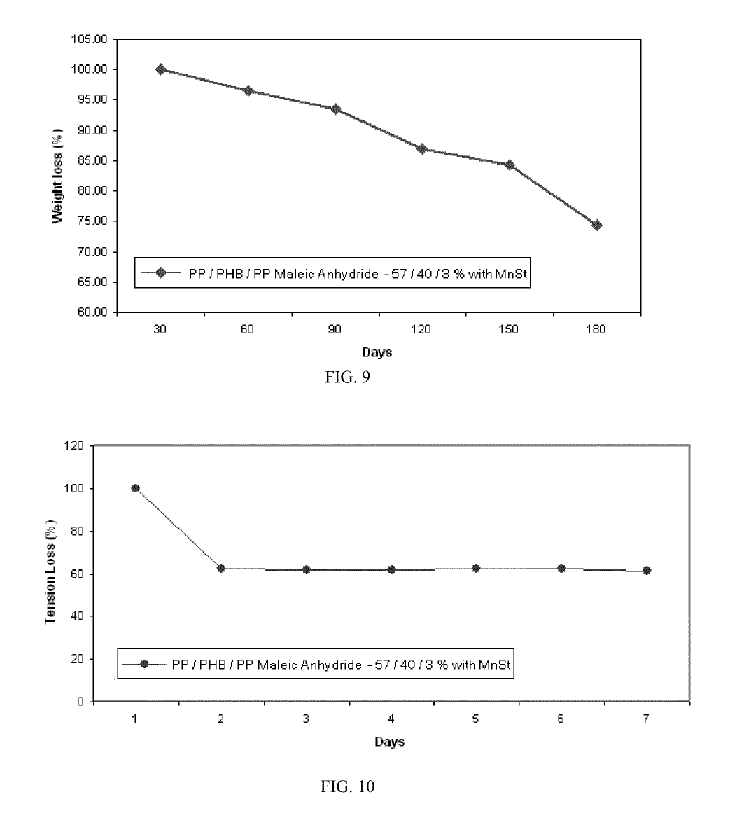

Next, the biodegradability of the samples was tested. Biodegradability was based on weight as measured according to ASTM D 6003. The specimens were buried in simulated soil compost at room temperature (24° C.). The simulated soil consisted of 23% loamy silt, 23% organic matter (cow manure), 23% sand and 31% distilled water (all wt/wt). Biodegradation was monitored for 180 days by measuring the tensile strength retention approximately each 30 days. The buried specimens were recovered, washed with distilled water and dried at room temperature until there was no further variation in weight, after which they were evaluated for tensile strength. Additionally, the weight loss of the specimens was tracked along the burring time. The experiments were done in triplicate. The results may be seen in FIGS. 9 and 10. As may be seen, the simulated soil compost substantially increased the weight loss and, therefore, enabled the sample to be considered biodegradable rating 3 as per Table X2.1 under ASTM D 6003.

While typical embodiments have been set forth for the purpose of illustration, the foregoing descriptions should not be deemed to be a limitation on the scope of the invention. Accordingly, various modifications, adaptations, and alternatives may occur to one skilled in the art without departing from the spirit and scope of the present invention.

What is claimed is:

1. A thermoplastic composition, comprising:
a) 10 to 80% by weight of a polyhydroxyalkanoate polyester;
b) 10 to 80% by weight of a conventional polymer having a melting temperature of 220° C. or less;
c) 0.5 to 10% by weight of a compatibilizer; and
d) from 0.2 to 10% by weight of a pro-degradation additive.

2. The thermoplastic composition of claim 1 wherein the polyhydroxyalkanoate polyester is selected from polyhydroxybutyrate, poly(3-hydroxybutyrate, polyhydroxyvalerate, polyhydroxyhexanoate, poly(3-hydroxybutyrate-co-3-hydroxyvalerate) copolymer, poly-hydroxybutyrate-co-polyhydroxyhexanoate copolymer, or a combination comprising at least one of the foregoing polyhydroxyalkanoate polyester polymers.

3. The thermoplastic composition of claim 1 wherein the conventional polymer is selected from a polyolefin, a polyester, a polyamide, a styrene-containing polymer or a combination comprising at least one of the foregoing polymers.

4. The thermoplastic composition of claim 3 wherein the conventional polymer is a polyolefin selected from polypropylene, polyethylene, high density polyethylene, low density polyethylene or a combination comprising at least one of the foregoing polyolefins.

5. The thermoplastic composition of claim 3 wherein the conventional polymer is a polyamide and the polyamide comprises nylon 6.

6. The thermoplastic composition of claim 3 wherein the conventional polymer is a styrene-containing polymer and the styrene-containing polymer comprises acrylonitrile-butadiene-styrene.

7. The thermoplastic composition of claim 1 wherein the compatibilizer is selected from ethylene copolymers, maleic anhydride grafted polyolefins or a combination comprising at least one of the foregoing compatibilizers.

8. The thermoplastic composition of claim 7 wherein the compatibilizer is a maleic anhydride grafted polyolefin selected from maleic anhydride grafted polypropylene, maleic anhydride grafted low density polyethylene, maleic anhydride grafted low density polyethylene or a combination comprising at least one of the foregoing maleic anhydride grafted polyolefins.

9. The thermoplastic composition of claim 7 wherein the compatibilizer is an ethylene copolymer selected from ethylene methyl acrylate, ethylene ethyl acrylate, ethylene butyl acrylate, ethylene butyl acrylate glycidyl methacrylate or a combination comprising at least one of the foregoing ethylene copolymers.

10. The thermoplastic composition of claim 1 wherein the pro-degradation additive is selected from a transition metal stearate, a transition metal containing complex, transition metal oxide, oxide from Lanthanum series or a combination including at least one of the foregoing pro-degradation additives.

11. The thermoplastic composition of claim 10 wherein the pro-degradation additive is a transition metal stearate and the transition metal stearate comprises manganese stearate.

12. The thermoplastic composition of claim 10 wherein the pro-degradation additive is a transition metal oxide and the transition metal oxide comprises iron oxide.

13. The thermoplastic composition of claim 10 wherein the pro-degradation additive is an oxide from Lanthanum series and the oxide from Lanthanum series comprises cerium oxide.

14. The thermoplastic composition of claim 10 wherein the pro-degradation additive is a transition metal containing complex and the transition metal containing complex comprises a cobalt complex.

15. An article of manufacture comprising the composition of claim 1.

16. The article of manufacture of claim 15, wherein the article of manufacture is selected from an injection-molded bottle, a plastic film, a cosmetic container, a cell phone, a laptop, or a packaging application.

17. A method of forming a thermoplastic composition comprising the steps of:
blending
a) 10 to 80% by weight of a polyhydroxyalkanoate polyester;
b) 10 to 80% by weight of a conventional polymer having a melting temperature of 220° C. or less;
c) 0.5 to 10% by weight of a compatibilizer; and
d) from 0.2 to 10% by weight of a pro-degradation additive.

18. The method of claim 17 wherein the polyhydroxyalkanoate polyester is selected from polyhydroxybutyrate, poly(3-hydroxybutyrate, polyhydroxyvalerate, polyhydroxyhexanoate, poly(3-hydroxybutyrate-co-3-hydroxyvalerate) copolymer, poly-hydroxybutyrate-co-polyhydroxyhexanoate copolymer, or a combination comprising at least one of the foregoing polyhydroxyalkanoate polyester polymers.

19. The method of claim 17 wherein the conventional polymer is selected from a polyolefin, a polyamide, a styrene-containing polymer or a combination comprising at least one of the foregoing polymers.

20. The method of claim 19 wherein the conventional polymer is a polyolefin selected from polypropylene, polyethylene, high density polyethylene, low density polyethylene or a combination comprising at least one of the foregoing polyolefins.

21. The method of claim 17 wherein the compatibilizer is selected from ethylene copolymers, maleic anhydride grafted polyolefins or a combination comprising at least one of the foregoing compatibilizers.

22. The method of claim 17 wherein the pro-degradation additive is selected from a transition metal stearate, a transition metal containing complex, transition metal oxide, oxide from Lanthanum series or a combination including at least one of the foregoing pro-degradation additives.
